(19) United States
(12) Patent Application Publication
(10) Pub. No.: US 2008/0246202 A1
(43) Pub. Date: Oct. 9, 2008

(54) Spring screw assembly

(75) Inventors: Ting-Jui Wang, Taipei (TW); Ming-De Wu, Taipei (TW)

Correspondence Address: TING-JUI WANG, 20525 Via Talavera, Yorba Linda, CA, 92887, US

(73) Assignee: FIVETECH TECHNOLOGY INC.

(21) Appl. No.: 11/784,471

(22) Filed: Apr. 9, 2007

(51) Int. Cl. F16B 37/12

(52) U.S. Cl. 267/178

(57) ABSTRACT

A spring screw assembly includes a screw, an inner tube having a spring mounted therein, and a retainer tube being covered by a color coat. The inner tube is axially movably assembled into the retainer tube, and the screw may be extended into the retainer tube and the inner tube to extend through the spring with a rack portion near an upper end of the screw tightly engaged with an upper open end of the retainer tube. Therefore, screws of different sizes and retainer tubes with different color coats may be separately kept in stock, and screws meeting customer specifications may be assembled to retainer tubes having colors meeting customer color management system at a later time to complete the desired spring screw assemblies.

### FIELD OF THE INVENTION

The present invention relates to a spring screw assembly that includes a screw and a retainer tube that could be separately kept in stock, so that a screw having a desired size may be assembled to a retainer tube having a desired color at a later time to meet customer's color management policy in screw.

### BACKGROUND OF THE INVENTION

A spring screw has long been an important means for fastening two objects together. There are spring screws of different sizes, specifications, shapes, and patterns produced corresponding to screw holes of different diameters. Since all the spring screws usually have a similar metallic color, they are not easily distinguished from one another to cause difficulties in color management of spring screws. To solve this problem, some screw dealers try to enable color management of spring screws by directly putting a specific color coat on each differently sized spring screw, so that a user can easily visually determine a spring screw with a specific color coat is to be screwed to what position on a circuit board, for example. In this manner, a repair or maintenance worker may easily recognize and utilize the spring screw color management system to helpfully upgrade the productivity.

However, in the prior art, the color coat is injection molded on the head of the spring screw when the spring screw is manufactured. The produced spring screw with the color coat would become completely useless to cause serious loss in business in the event the designed screw hole is changed in size later.

It is therefore desirable to develop an improved spring screw assembly that includes a spring screw and a color coated retainer tube that could be separately prepared and kept in stock, and screws of different sizes and shapes may be separately assembled to retainer tubes of different colors completely according to customer's order and color management system.

In this manner, the spring screw assembly allows free and flexible match between the screw and the color coated retainer tube.

### SUMMARY OF THE INVENTION

A primary object of the present invention is to provide a spring screw assembly that includes a screw and a color coated retainer tube that could be separately kept in stock, so that a screw having a desired size may be assembled to a retainer tube having a desired color at a later time to complete a color coated spring screw assembly to meet customer's color management policy in screw.

To achieve the above and other objects, the spring screw assembly according to the present invention includes a screw, an inner tube having a spring mounted therein, and a retainer tube being covered by a color coat. The inner tube is axially movably assembled into the retainer tube, and the screw may be extended into the retainer tube and the inner tube to extend through the spring with a rack portion near an upper end of the screw tightly engaged with an upper open end of the retainer tube. The color coat covers a circumferential outer surface of the retainer tube, and is provided on an outer surface with a plurality of anti-slip grooves.

Therefore, screws of different sizes and retainer tubes with different color coats may be separately kept in stock, and screws meeting customer specifications may be assembled to retainer tubes having colors meeting customer color management system at a later time to complete the desired color coated spring screw assemblies. In this manner, the spring screw assembly of the present invention allows free and flexible match between the screw and the retainer tube covered with the color coat.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a spring screw assembly according to a preferred embodiment of the present invention;

FIG. 2 is an assembled view of FIG. 1;

FIG. 3 is an assembled sectional view of the spring screw assembly of the present invention ready for screwing; and

FIG. 4 is another assembled sectional view of the spring screw assembly of the present invention having been screwed into an object.

### DETAILED DESCRIPTION OF THE PREFERRED EMBODIMENTS

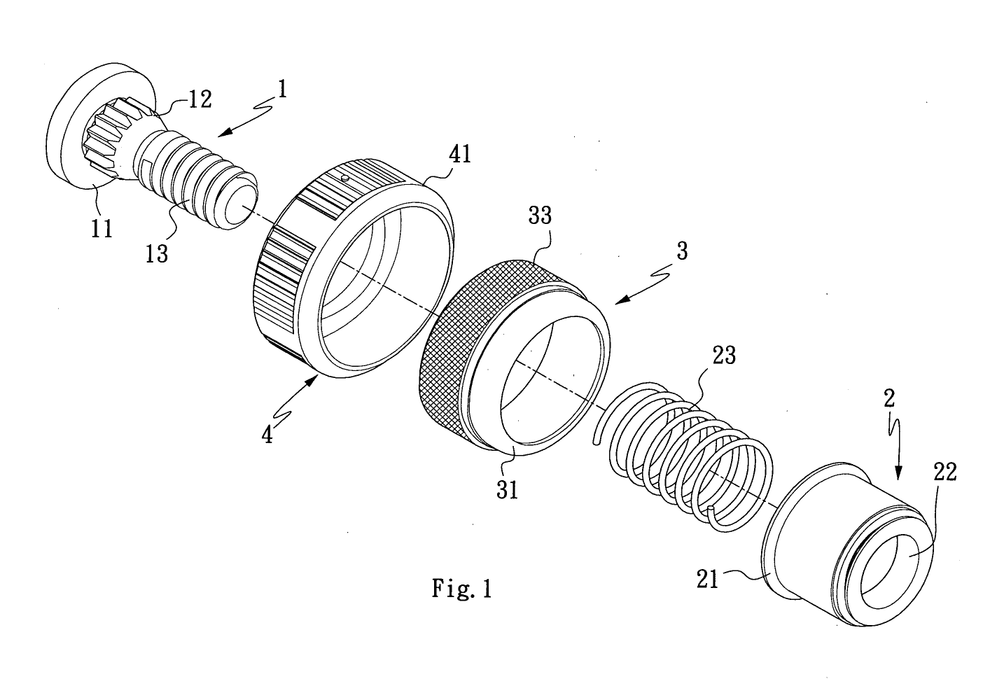

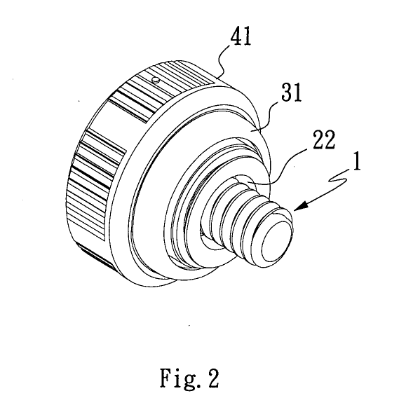

Please refer to FIGS. 1 and 2 that are exploded and assembled perspective views, respectively, of a spring screw assembly according to a preferred embodiment of the present invention. As shown, the spring screw assembly of the present invention includes a screw 1, an inner tube 2, and a retainer tube 3.

The screw 1 includes a head portion 11 being provided at a top surface with a slot (not shown) for receiving a screwdriver tip (not shown); a rack portion 12 downward extended from a bottom surface of the head portion 11; and an externally threaded shank 13 downward extended from the rack portion 12.

The inner tube 2 is provided around an upper open end with a radially outward extended flange 21, and in and around a lower open end with a radially inward extended shoulder portion 22, so that a spring 23 may be received in the inner tube 2 and the screw 1 may be extended into the inner tube 2 and through the spring 23.

The retainer tube 3 is a hollow member having an outer circumferential surface, which is provided with a plurality of anti-slip grooves 33 and covered by an insulating color coat 4. The color coat 4 is provided on a circumferential outer surface with a plurality of axial anti-slip flutes 41. The retainer tube 3 is provided around a lower open end with a first radially inward extended flange 31, against an inner side of which the outward flange 21 may be pressed. The retainer tube 3 is also provided around an upper open end with a second radially inward extended flange 32, such that the threaded shank 13 of the screw 1 may be extended into the retainer tube 3 and the inner tube 2 by forcing the rack portion 12 through the second inner flange 32 to tightly engage therewith. Meanwhile, the spring 23 is pressed at an upper end against an inner side of the second inward flange 32 and at a lower end against the shoulder portion 22.

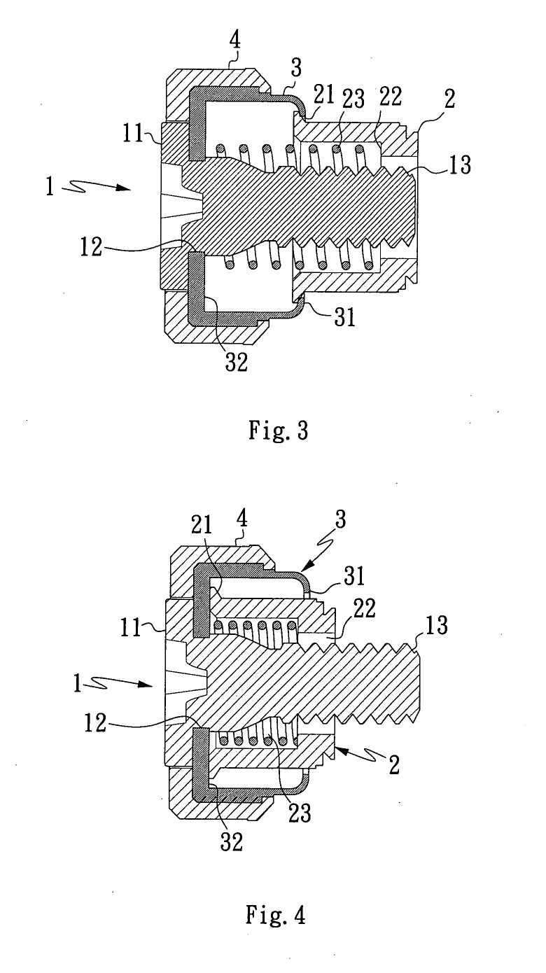

Please refer to FIG. 3 that is an assembled sectional view showing the spring screw assembly of the present invention is ready for screwing the screw 1 to an object. To screw the screw 1 to an object (not shown), first press the lower end of the inner tube 2 against an outer surface of the object, and turn the screw 1 downward. At this point, the inner tube 2 is gradually retracted into the retainer tube 3 to compress the spring 23 in the inner tube 2, and the threaded shank 13 is gradually extended from the lower open ends of the inner tube 2 and the retainer tube 3 to screw into the object, as shown in FIG. 4.

FIG. 4 is another assembled sectional view showing the spring screw assembly of the present invention in a fully screwed position. To remove the spring screw assembly from the object, simply turn the screw 1 upward to loosen it from the object. At this point, the inner tube 2 is pushed by a restoring force of the compressed spring 23 to gradually move outward from the retainer tube 3, and the threaded shank 13 of the screw 1 is gradually retracted into the inner tube 2 and the retainer tube 3.

With the above arrangements, the color coat 4 may be directly associated with the retainer tube 3 at the stage of injection molding, and a screw 1 with desired head type and size may be then picked and extended into the retainer tube 3 to tightly engage the rack portion 12 on the screw 1 with the second inward flange 32 of the retainer tube 3. The inner tube 2 may be correspondingly assembled into the retainer tube 3. In this manner, the spring screw assembly of the present invention allows free and flexible match between different screws 1 and retainer tubes 3 showing different colors.

What is claimed is:

1. A spring screw assembly, comprising:
a screw including a head portion being provided at a top surface with a slot for receiving a screwdriver tip; a rack portion downward extended from a bottom surface of the head portion; and an externally threaded shank downward extended from the rack portion;
an inner tube being provided around an upper open end with a radially outward extended flange, and in and around a lower open end with a radially inward extended shoulder portion, such that a spring may be received in the inner tube and the screw may be extended into the inner tube and through the spring; and
a retainer tube having an outer circumferential surface covered by an insulating color coat; the retainer tube being provided around a lower open end with a first radially inward extended flange, against an inner side of which the outward flange of the inner tube may be pressed, and around an upper open end with a second radially inward extended flange, such that the threaded shank of the screw may be extended into the retainer tube and the inner tube by forcing the rack portion through the second inner flange of the retainer tube to tightly engage therewith, and the spring in the inner tube is pressed at an upper end against an inner side of the second inward flange and at a lower end against the shoulder portion of the retainer tube.

2. The spring screw assembly as claimed in claim 1, wherein the color coat is provided on a circumferential outer surface with a plurality of axial anti-slip flutes.
